(19) United States
(12) Patent Application Publication
(10) Pub. No.: US 2006/0222390 A1
(43) Pub. Date: Oct. 5, 2006

(54) Electrophotographic image forming device and developing method thereof

(75) Inventors: Tsutomu Sasaki, Suwon-si (KR); Kyu-cheol Shin, Seoul (KR); Myung-kook Ahn, Suwon-si (KR); Masahiko Itaya, Suwon-si (KR); Tsutomu Teraoka, Seongnam-si (KR); Naonori Kurogawa, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/342,632

(22) Filed: Jan. 31, 2006

(30) Foreign Application Priority Data
Apr. 4, 2005 (KR) 2005-0028072
Oct. 18, 2005 (KR) 2005-0098076

(51) Int. Cl. G03G 15/09

(52) U.S. Cl. 399/55; 399/270; 399/272; 399/273

(57) ABSTRACT

Provided is an image forming device performing hybrid development that uses magnetic carriers and nonmagnetic carriers. An electrical potential of a non-image portion on an image holder and an electrical potential of a direct current component of a developing bias voltage applied to a developing roller are determined so that a difference between the electrical potentials are less than or equal to a value at which a developing rate of the non-image portion is saturated.

### CROSS-REFERENCE TO RELATED PATENT APPLICATIONS

This application claims the benefit under 35 U.S.C. §119(a) of Korean Patent Application No. 10-2005-0028072, filed on Apr. 4, 2005, and Korean Patent Application No. 10-2005-0098076, filed on Oct. 18, 2005, in the Korean Intellectual Property Office, the entire disclosures of which are hereby incorporated by reference.

### BACKGROUND OF THE INVENTION

1. Field of the Invention

The present invention relates to an electrophotographic image forming device and a developing method performed by the electrophotographic image forming device. More particularly, the present invention relates to an electrophotographic image forming device using magnetic carriers and nonmagnetic carriers and a developing method performed by the electrophotographic image forming device.

2. Description of the Related Art

Examples of image development used in an image forming device using electrophotography, include two-component development, single-component development and hybrid development. Two-component development uses toner and magnetic carriers. Single-component development uses only an insulative toner or a conductive toner. In hybrid development, only charged toner is attached onto a developing roller and transferred to an electrostatic latent image, and the electrostatic latent image is developed using a two-component developing agent in which nonmagnetic toner and magnetic carriers are mixed. Exemplary image forming devices using electrophotography include copiers, printers, facsimiles and multi-function devices.

Two-component development has the advantages of excellent toner electrification, a long life span for the image forming device, and the ability to form uniform images. However, the two-component development has the disadvantages of the developing device being relatively large and complicated, toner scattering, attachment of carriers to a latent image, and degradation of images due to a reduced durability of carriers, among other things.

Single component development has the advantages of a compact developing device and excellent dot reproducibility. However, single component development also has its disadvantages. For instance, performance of a developing roller and a charge roller degrades with use and thus the developing device is not durable. Further, when the toner supply is exhausted, the whole developing device must be replaced, so it is costly. Furthermore, selective development may occur. Selective development denotes attachment of only a portion of the toner, having a predetermined weight and a predetermined amount of charge on a developing roller, to an electrostatic latent image. When such selective development continues, residual toner, that is, toner having a weight and charge less than the predetermined values, is not used during development, resulting in a reduced toner usage rate.

Hybrid development has the advantages of having excellent dot reproduction, a long lifespan developing device, and the quick formation of images. Japanese Patent Publication Nos. hei 6-67546, hei 7-72733 (which corresponds to U.S. Pat. No. 5,420,375), and hei 7-92804 disclose hybrid developing devices, the entire disclosures of which are hereby incorporated by reference. In hybrid developing devices, toner is supplied to a developing roller by a magnetic roller. Electrodes are installed between the developing roller, and a photosensitive conductor. A bias voltage in which a direct current (DC) and an alternating current (AC) are mixed is applied to the space between the electrodes and the developing roller to form a toner cloud around the electrodes and develop an electrostatic latent image on the photosensitive conductor.

In the development system where electrodes are installed between the developing roller and the photosensitive conductor, there is a problem in that either irregular development occurs due to a vibration of electrode wires electrically biased and tensed, or stripped traces develop on the developing roller due to instant attachment of dust to the electrodes. To solve the above problem, Japanese Patent Publication No. hei 2000-250294 discloses a development system using a developing roller in which electrodes are covered, the entire disclosure of which is hereby incorporated by reference. Since the development system needs a brush electrode for supplying a combined AC and DC bias voltage to the buried electrodes, the development system is complicated and expensive. Additionally, when the brush electrode is contaminated or toner is fused to the brush electrode, it is impossible to make contact between the brush electrode and the electrodes of the developing roller. Furthermore, when consecutive image patterns of high concentration are developed, fine toner powder and a contaminating material produced from the toner are attached to the developing roller, thereby causing a toner film on the developing roller. Thus, a toner layer on the developing roller becomes irregular and may result in image irregularities, such as the generation of spots on an image.

In hybrid development, there exist problems, such as the occurrence of ghost images being development, attachment of toner to a developing roller due to leaving toner on the developing roller for a long time, and other similar problems. To solve these problems, a DC bias voltage whose polarity is changeable, which is disclosed in Japanese Patent Publication No. hei 7-72733, or an AC bias voltage combined with the DC bias voltage, which is disclosed in Japanese Patent Publication Nos. hei 6-67546 and 7-92804, is applied to the magnetic roller. In Japanese Patent Publication Nos. hei 7-72733 and 7-92804, upon completion of image formation, the polarity of the DC bias voltage applied to the magnetic roller is changed, and an electric field having a direction capable of collecting toner from the developing roller to the magnetic roller is supplied between the developing roller and the magnetic roller. Meanwhile, in Japanese Patent Publication No. hei 6-67546, the polarity change of the DC bias voltage and the supply of the electric field occur at regular intervals. The supply of the special electric field to collect toner from the developing roller causes the toner to be electrically stressed. Consequently the durability of the toner is degraded which results in the property of the toner being changed. In addition, fast printing is hindered because time is required during next development to form a toner layer having an appropriate thickness on the developing roller.

Accordingly, there is a need for an improved electrophotographic image forming device and a developing method performed by the electrophotographic image forming device that allows toner remaining on the developing roller to be easily removed, so that development of a ghost image can be prevented.

### SUMMARY OF THE INVENTION

An aspect of the present invention is to address at least the above problems and/or disadvantages and to provide at least the advantages described below. Accordingly, an aspect of the present invention is to provide a simple hybrid developing method by which development of a ghost image is prevented, image irregularity is not generated even during consecutive printing, and stable images of high quality can be obtained for a long period of time, and an electrophotographic image forming device which performs the simple hybrid developing method.

According to an aspect of an exemplary embodiment of the present invention, there is provided an electrophotographic image forming device comprising an image holder on which an electrostatic latent image including an image portion and a non-image portion is formed. Further included is a magnetic roller for forming, by a magnetic force, a magnetic brush comprising nonmagnetic toner and a magnetic carrier. Additionally the electrophotographic image forming device comprises a developing roller disposed between the image holder and the magnetic roller for receiving toner from the magnetic roller and for forming a toner layer on an outer circumference of the developing roller Also included is a bias applying unit applying to the magnetic roller a supply bias voltage effective in supplying toner to the developing roller and for applying to the developing roller a developing bias voltage effective in developing the toner into the electrostatic latent image. A difference between an electrical potential of the non-image portion and a potential of a direct current (DC) component of the developing bias voltage is less than or equal to a value at which a developing rate of the non-image portion is saturated.

The developing rate may be calculated using the following equation:
developing rate={(ODBD−ODAD)/ODBD}×100%.

In the above equation, ODBD is the optical density of a toner layer on developing roller before development and ODAD is optical density of a toner layer on developing roller after development.

The electrophotographic image forming device may further include a collecting roller disposed farther downstream than the developing roller as viewed in a direction where the image holder is rotated. The bias applying unit may apply to the collecting roller a collecting bias voltage that provides an electric field for transferring toner attached to the non-image portion on the image holder to the collecting roller.

A relationship among the electrical potentials of DC components of the developing bias voltage, the supply bias voltage, and the collecting bas voltage may be given by:
|DCSB|>|DCDB|>|DCCB|

In the above relationship, DCSB is the potential of direct current component of supply bias voltage, DCDB is the potential of direct current component of developing bias voltage and DCCB is the potential of direct current component of collecting bas voltage.

The magnetic roller may rotate so that a surface area of the magnetic roller adjacent to surface areas of the developing roller and the collecting roller can move in a direction opposite to a direction in which the surface areas of the developing roller and the collecting roller move.

The distance between the developing roller and the image holder may be in the range of 150 to 400 μm.

An distance between the collecting roller and the image holder may be less than or equal to a distance between the developing roller and the image holder.

A distance between the developing roller and the magnetic roller may be in the range of 0.2 to 1.0 mm.

According to another aspect of an exemplary embodiment of the present invention, there is provided an electrophotographic image forming device comprising an image holder on which an electrostatic latent image including an image portion and a non-image portion is formed, a magnetic roller for forming by a magnetic force a magnetic brush comprising nonmagnetic toner and a magnetic carrier. Further included is a developing roller and a collecting roller disposed upstream and downstream, respectively, as viewed in a direction of rotation of the image holder, between the image holder and the magnetic roller. Also included is a bias applying unit applying to the magnetic roller a supply bias voltage effective in supplying toner to the developing roller and for applying to the developing roller a developing bias voltage effective in developing the toner into the electrostatic latent image, the developing bias voltage being a combination of a direct current and an alternating current, and a collecting bias voltage effective in collecting toner attached to the non-image portion on the collecting roller. A difference between a potential of the non-image portion and a potential of a direct current component of the developing bias voltage is less than or equal to a value at which a developing rate of the non-image portion is saturated, the developing rate being calculated using the following equation:
developing rate={(ODBD−ODAD)/ODBD}×100%.

In the above equation, ODBD is the optical density of a toner layer on developing roller before development and ODAD is optical density of a toner layer on developing roller after development.

According to another aspect of an exemplary embodiment of the present invention, there is provided a hybrid developing method of supplying toner from a magnetic brush of a magnetic roller to a developing roller and applying a developing bias voltage to the developing roller to develop the toner into an electrostatic latent image on an image holder. In the hybrid developing method, the developing bias voltage is set so that a difference between an electrical potential of a direct current component of the developing bias voltage and an electrical potential of a non-image portion of the electrostatic latent image is no more than a potential difference at which the developing rate of the non-image portion is saturated, and the set developing bias voltage reduces the adhesion of toner remaining on the developing roller after development to the developing roller.

The magnetic roller is rotated so that a surface thereof can move in direction opposite to a direction in which a surface area of the developing roller moves. The magnetic brush of the magnetic roller contacts the developing roller to remove the toner remaining on the developing roller after development.

The toner attached to the non-image portion on the developing roller is collected on a collecting roller disposed farther downstream than the developing roller as viewed in a rotating direction of the image holder by applying a collecting bias voltage to the collecting roller. The magnetic roller is rotated so that a surface thereof can move in direction opposite to a direction in which a surface areas of the developing roller and the collecting roller move. The magnetic brush of the magnetic roller contacts the developing roller and the collecting roller to remove the toner remaining on the developing roller after development and the toner detached from the non-image portion and collected on the collecting roller.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 illustrates a structure of an image forming device according to an exemplary embodiment of the present invention;

FIG. 2 illustrates magnetic brushes according to an exemplary embodiment of the present invention;

FIG. 3 is a graph showing a developing rate for an image or non-image portion;

FIG. 4 illustrates a developing process of the image forming device of FIG. 1 when the developing rate is saturated; and

FIG. 5 illustrates a developing process of the image forming device of FIG. 1 when the developing rate is not saturated.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

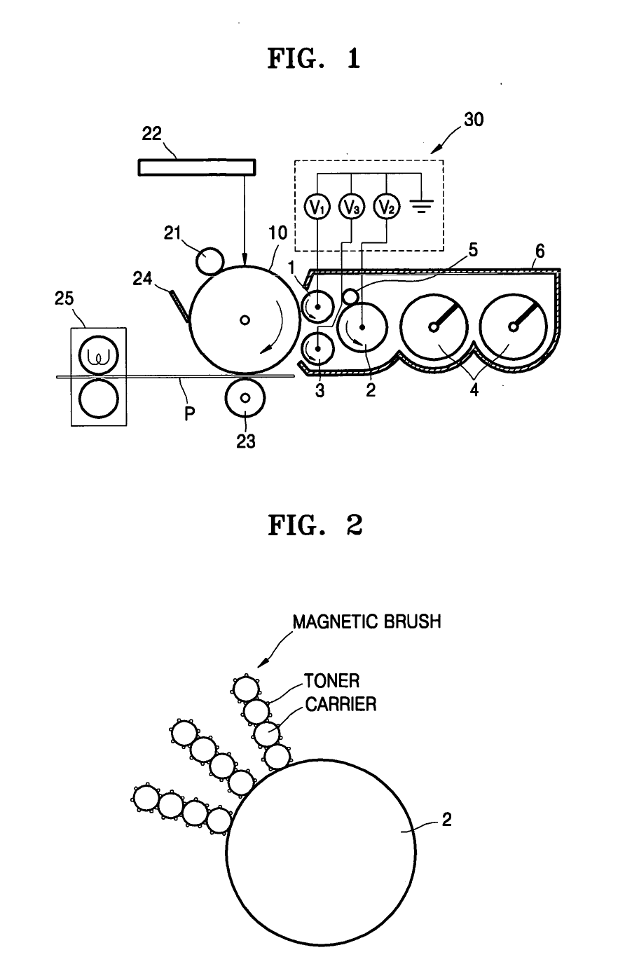

An image forming device according to an exemplary embodiment of the present invention will now be described in detail with reference to the accompanying drawings, in which exemplary embodiments of the invention are shown. Referring to FIG. 1, an image forming device according to an exemplary embodiment of the present invention includes an image holder 10, a developing roller, a magnetic roller 2, a collecting roller 3, and an agitator 4. In this embodiment, an amorphous silicon photosensitive conductor is used as the image holder 10. Alternatively, an organic photosensitive conductor may be used as the image holder 10. A charger 21 and an exposer 22 are included to form an electrostatic latent image on the image holder 10. A corona discharger or a charge roller may be used as the charger 21. A laser scanning unit (LSU) radiating laser light may be used as the exposer 22. An electrostatic drum (not shown) may be used as the image holder 10. In this case, an electrostatic recording head (not shown) instead of the exposer 22 is used to form the electrostatic latent image.

A housing 6 contains nonmagnetic toner and magnetic carriers. The agitator 4 agitates the magnetic carriers and the nonmagnetic toner to rub against each other so as to charge the toner. The carriers are attached to an outer circumference of the magnetic roller 2 by a magnetic force of the magnetic roller 23, and the charged toner is attached to the carriers by static electricity. Then, as shown in FIG. 2, magnetic brushes comprised of carriers and toner are formed on the outer circumference of the magnetic roller 2. A trimmer 5 controls the magnetic brushes so that they have a predetermined thicknesses. A distance between the trimmer 5 and the magnetic roller 2 is preferably, but not necessarily, about 0.3 to 1.5 mm.

The developing roller 1 is located between the image holder 10 and the magnetic roller 2. A gap between the developing roller 1 and the image holder 10, referred to as a developing gap, may be about 150 to 400 μm and is preferably about 200 to 300 μm. When the developing gap is smaller than 150 μm, image fadedness occurs. When the developing gap is greater than 400 μm, it is difficult to transfer toner onto the image holder 10. This results in not being able to obtain a sufficient image concentration which causes selective development. The distance between the magnetic roller 2 and the developing roller 1 may be about 0.2 to 1.0 mm and is preferably about 0.3 to 0.4 mm. The developing roller 1 may be either a sleeve formed of conductive aluminum or stainless steel or a sleeve coated with conductive resin. The developing roller 1 may have a volume resistivity of 10⁶Ω·cm³ or less.

A bias applying unit 30 applies a developing bias voltage V₁, a supply bias voltage V₂, and a collecting bias voltage V₃ to the developing roller, the magnetic roller 2, and the collecting roller 3, respectively. The supply bias voltage V₂ is used to provide an electric field between the magnetic roller 3 and the developing roller 1 which is effective in transferring a toner from the magnetic roller 2 to the developing roller 1. A direct current(DC) bias voltage or a bias voltage in which a DC bias voltage and an alternating current (AC) bias voltage overlap may be used as the supply bias voltage V₂. A toner layer is formed on an outer circumference of the developing roller 1 by the supply bias voltage V₂. The developing bias voltage V₁ is used to separate toner from the toner layer formed on the outer circumference of the developing roller 1 and is used to move the toner onto an electrostatic latent image on the image holder 10 via the developing gap. To achieve this, a bias voltage in which a DC bias voltage and an AC bias voltage overlap is used as the developing bias voltage V₁.

In this structure, the charger 21 charges a surface of the image holder 10, which is a photosensitive conductor, to a uniform potential. The exposer 22 projects light corresponding to image information onto the image holder 10. As a result, an electrostatic latent image constituted of an image portion and a non-image portion having different potentials is formed on the surface of the image holder 10. Toner is separated from magnetic brushes on the magnetic roller 2 by the supply bias voltage V₂ applied thereto and is transferred to the developing roller 1. A uniform toner layer is formed on the outer circumference of the developing roller 1. When the toner layer formed on the developing roller 1 faces the image portion of the electrostatic latent image while passing in the developing gap, toner is separated from the toner layer on the developing roller 1 by the developing bias voltage V₁ and attached to the image portion to develop the electrostatic latent image into a visible toner image. The toner image is transferred onto a recording medium P by a transporting electric field provided by a transfer roller 23. A fuser 25 fuses the toner image onto the recording medium P using heat and pressure, and a cleaning blade 24 removes residual toner from the surface of the image holder 10.

When the toner layer formed on the developing roller 1 faces the non-image portion of the electrostatic latent image while passing the developing gap, the toner layer is subject to a strong electrical attractive force by a difference between the potential of a DC component of the developing bias voltage V₁ and the potential of the image portion, and is thus strongly attached to the developing roller 1. The toner remaining on the developing roller 1, after passing through the developing gap, is removed from the developing roller 1 by the magnetic brushes formed on the magnetic roller 2, and simultaneously, new toner is supplied to the developing roller 1. However, the toner layer facing the non-image portion is not completely removed because it has been subject to the strong electrical attractive force. At this time, when new toner is supplied from the magnetic roller 2 to the developing roller 1, a toner layer with a non-uniform thickness is formed. Hence, an image with a non-uniform concentration is developed on the image holder 10 or a ghost image is developed. A ghost image is an afterimage from a previous development appearing on a current development.

To solve these problems, there is a need to decrease the degree of attachment of the toner layer facing the non-image portion while passing the developing gap to the developing roller 1. In the image forming device according to the present embodiment, the adhesion of the toner layer to the developing roller 1 is weakened by controlling the potential of the DC component of the developing bias voltage V₁. FIG. 3 is a graph showing a relationship between a developing rate of the image or non-image portion and a difference ΔV between the potential V₁dc of the DC component of the developing bias voltage V₁ and the potential Vi or Vb of the image portion or the non-image portion. In FIG. 3, the vertical axis indicates a developing rate of the image portion or the non-image portion, and the horizontal axis indicates an absolute value of the difference ΔV to display both the differences ΔV for the image portion and the non-image portion on the graph. The developing rate of the image portion (or the non-image portion) denotes a percentage of toner attached onto an area of the developing roller 1 facing the image portion (or the non-image portion) on the image holder 10 before development occupied by toner that is transferred to the image portion (or the non-image portion) during development. For example, the developing rate may be calculated by the following equation:
developing rate={(ODBD−ODAD)/ODBD}×100%.

In the above equation, ODBD is the optical density of a toner layer on developing roller before development and ODAD is optical density of a toner layer on developing roller after development.

The amount of toner may be represented as an optical density. An optical density is a numerical value of the detected amount of light reflected from an irradiated surface of the developing roller 1.

Ideally toner from the developing roller 1 is attached only to the image portion of the image holder 10. To achieve this, a developing bias voltage V1 should be set such that the potential difference ΔV for the non-image portion is greater than a potential difference ΔVs. This results in a developing rate at which the non-image portion is saturated. The saturation of the developing rate of the non-image portion denotes 0% development of the non-image portion which is 100% development of the image-portion.

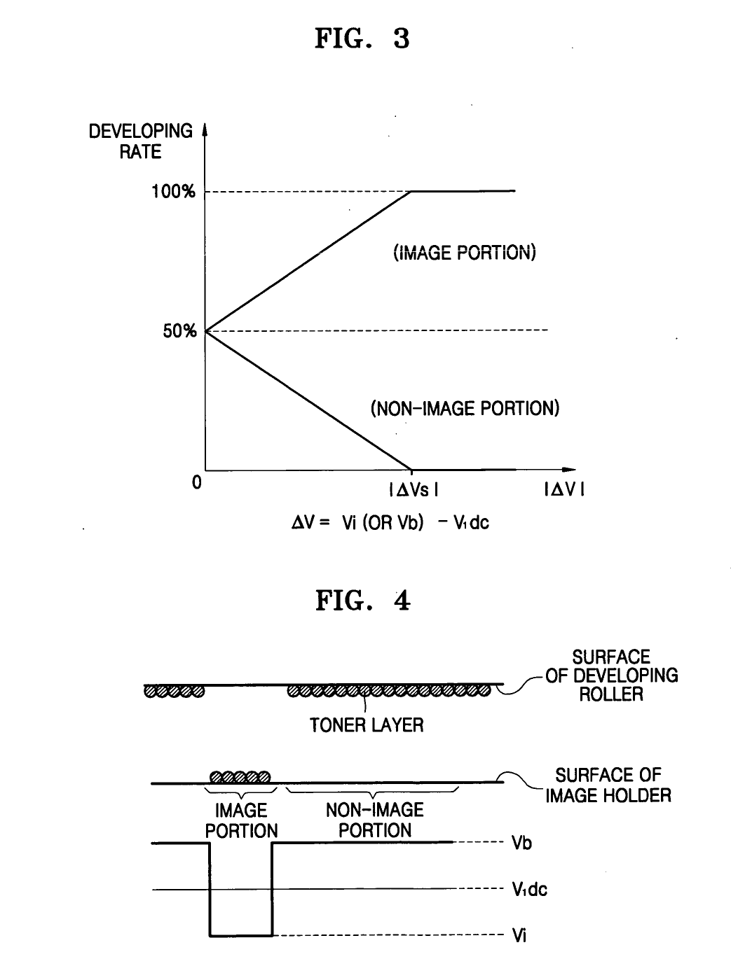

As shown in FIG. 4, when the set developing bias-voltage V₁ is applied to the developing roller 1, no toner is attached to the non-image portion on the image holder 10. Instead, the toner layer on the developing roller 1 is subject to a strong electrical attractive force, so that the attachment of toner to the developing roller 1 becomes very strong. Hence, as described above, it is very difficult to remove the remaining toner from the developing roller 1 after development.

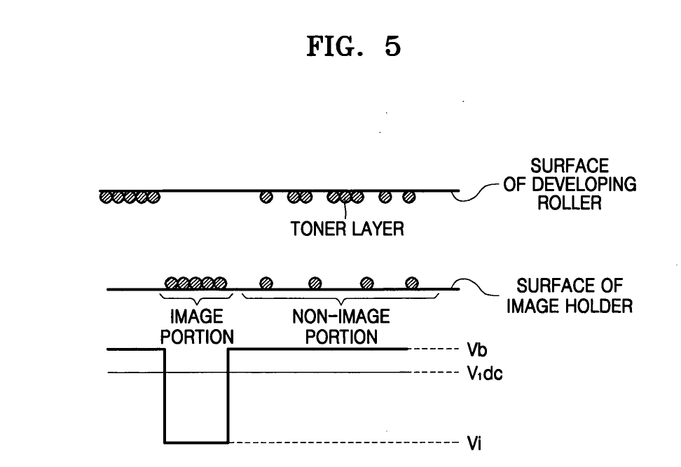

On the other hand, when a developing bias voltage V₁, that is set such that the difference ΔV is smaller than the potential difference ΔVs, is applied to the developing roller, some of toner is attached to the non-image portion on the image holder 10, as shown in FIG. 5. However, the attachment of the remaining toner that has not been developed by the developing roller 1 to the developing roller 1, becomes very weak. Accordingly, the remaining toner on the developing roller 1 is easily removed by the magnetic brushes formed on the outer circumference of the magnetic roller 2. Consequently, a toner layer with a uniform thickness that is effective for the next development can be formed on the developing roller 1. By selecting a developing bias voltage V₁ that is suitable for making the potential difference ΔV be less than or equal to the potential difference ΔVs, image quality degradation due to the ghost phenomenon can be prevented. Furthermore, the toner's durability can be improved by reducing the stress applied to the toner from being removed from the developing roller 1 by the magnetic brushes.

To make the potential difference ΔV be less than or equal to the potential difference ΔVs, such that the developing rate of the non-image portion is saturated, the potential of the electrostatic latent image, namely the potential Vb of the non-image portion, may be controlled. Alternatively, both the potential of the developing bias voltage V₁ and the potential Vb of the non-image portion may be controlled.

Rotation of the magnetic roller 2 adjacent to a surface area of the developing roller 1 in a direction opposite the developing roller 1 is effective in removing remaining toner from the developing roller 1 and supplying new toner to the developing roller 1. Moreover, it is more effective to set the rotational speed of the magnetic roller 2 to be in the range of one to two times the rotational speed of the developing roller 1. Rotational speed of the magnetic roller 2 that is less than the rotational speed of the developing roller 1 is not enough to remove toner from the developing roller 1. When the rotational speed of the magnetic roller 2 is more than twice the rotational speed of the developing roller 1, toner stress is increased due to vibration or a generated heat.

As described above, toner may be attached to the non-image portion by determining a potential of the DC component of the developing bias voltage V₁ so that the potential difference ΔV is equal to or less than the potential difference ΔVs. The image forming device of FIG. 1 further includes the collecting roller 3 to remove toner from the non-image portion on the image holder 10. The bias applying unit 30 applies the collecting bias voltage V₃ to the collecting roller 3. The collecting bias voltage V₃ provides an electrical field having a direction that moves toner from the image holder 10 to the collecting roller 3. The collecting roller 3 is disposed farther downstream than the developing roller 1 as viewed in the direction of rotation of the image holder 10. The collecting roller 3 faces the image holder 10 and the magnetic roller 2. An interval between the collecting roller 3 and the image holder 10 is less than or equal to the developing gap. By applying the collecting bias voltage V₃ to the collecting roller 3, toner attached to the non-image portion is collected on the collecting roller 3, thereby improving the quality of an image. A rotational speed ratio of the collecting roller 3 to the magnetic roller 2 is the same as the rotational speed ratio of the developing roller 1 to the magnetic roller 2.

A relationship among the potentials of DC components of the developing bias voltage V₁, the supply bias voltage V₂, and the collecting bas voltage V₃ is given by:
|DCSB V₂|>|DCDB V₁|>|DCCB V₃|

In the above relationship, DCSB V₂ is the potential of direct current component of supply bias voltage, DCDB V₁ is the potential of direct current component of developing bias voltage and DCCB V₃ is the potential of direct current component of collecting bas voltage.

The collecting bias voltage V₃ is determined so as to remove toner from the non-image portion on the image holder 10 and not to remove or agitate toner on the image portion. When the mobility of the toner is great or a potential contrast of the electrostatic latent image is great, a difference between the potential of the image portion and the potential of the DC component of the collecting bias voltage V₃ is large. Hence, there is a small possibility that the toner attached to the image portion is agitated by the collecting bias voltage V₃. To the contrary, when the potential contrast of the electrostatic latent image is narrow, the difference between the potential of the image portion and the potential of the DC component of the collecting bas voltage V₃ should be increased to a sufficiently large value in order to prevent the toner attached to the image portion from being agitated by the collecting bias voltage V₃.

In an experiment, an amorphous silicon photosensitive conductor was used as the image holder 10, a charge potential of the image holder 10, namely the potential of a non-image portion, was set to 600V, and an exposure potential, namely the potential of an image portion, was set to 50V. The developing gap distance between the developing roller 1 and the image holder 10 was set to about 250 μm, and electrode wires used in conventional image forming devices were not installed between the developing roller 1 and the image holder 10. A bias voltage produced by overlapping a DC bias voltage V1dc with 500V potential and an AC bias voltage having 1.5 kV peak-to-peak voltage and 3.0 kHz frequency was applied as the developing bias voltage V₁ to the developing roller 1. The electrical characteristics of the collecting roller 3 were the same as those of the developing roller 1. A potential of a DC component of a collecting bias voltage V₃ applied to the collecting roller 3 was 450V, and a frequency and a peak-to-peak voltage of an AC component of the collecting bias voltage V3 was equal to those of the developing bias voltage V₁ applied to the developing roller 1. A potential of a DC component of a supply bias voltage V₂ applied to the magnetic roller 2 was 600V. The absolute value of the potential difference ΔVs, at which the developing rate of the non-image portion is saturated, was set to about 300V in consideration of all elements, such as, a developing gap, a particle diameter of toner, a weight of toner, among other things. The potential difference ΔV for the non-image portion was 100V, and the potential difference ΔV for the image portion was −450V. Accordingly, it was anticipated that the developing rate of the image portion was saturated, and the developing rate of the non-image portion was not saturated. Actually, the developing rates of the non-image portion and the image portion were 60% and 100%, respectively, and toner was attached to the non-image portion of the image holder 10. However, the toner was removed from the non-image portion and collected on the collecting roller 3 by the collecting bias voltage V₃ applied to the collecting roller 3. The toner collected on the collecting roller 3 was re-collected on the magnetic brush of the magnetic roller 2. Toner remaining on the surface of the developing roller 1, after passing through the developing gap, was also easily collected on the magnetic brush of the magnetic roller 2. In this experiment, toner remaining on the developing roller 1 after image development was easily removed there from, and stable image development was achieved even upon consecutive image printings.

Although a mono-color image forming device has been described above, the structure of the image forming device may be applied to single-pass color image forming devices having tandem structures and multi-pass color image forming devices which develop a single image holder several times and sequentially transports results of the several developments to an intermediate transport member.

As described above, an image forming device according to an exemplary embodiment, of the present invention has the following effects. First, adhesion of toner remaining on a developing roller after development is reduced by setting a potential of a DC component of a developing bias voltage and/or a potential of a non-image portion of an electrostatic latent image so that a difference between the potential of the non-image portion and the potential of the DC component of the, developing bias voltage is less than or equal to a potential difference at which a developing rate of the non-image portion on an image holder is saturated. Thus, the toner remaining on the developing roller is easily removed, so that development of a ghost image can be prevented. Second, toner attached to the non-image portion can be removed using an additional collecting roller.

While the invention has been shown and described with reference to certain embodiments thereof, it will be understood by those skilled in the art that various changes in form and details may be made therein without departing from the spirit and scope of the invention as defined by the appended claims.

What is claimed is:

1. An electrophotographic image forming device comprising:
an image holder on which an electrostatic latent image including an image portion and a non-image portion is formed;
a magnetic roller for forming by a magnetic force a magnetic brush comprising nonmagnetic toner and a magnetic carrier;
a developing roller disposed between the image holder and the magnetic roller for receiving toner from the magnetic roller and for forming a toner layer on an outer circumference of the developing roller; and
a bias applying unit for applying to the magnetic roller a supply bias voltage effective in supplying toner to the developing roller and for applying to the developing roller a developing bias voltage effective in developing the toner into the electrostatic latent image,
wherein a difference between an electrical potential of the non-image portion and an electrical potential of a direct current (DC) component of the developing bias voltage is less than or equal to a value at which a developing rate of the non-image portion is saturated.

2. The electrophotographic image forming device of claim 1, wherein the developing rate is calculated using the following equation:
developing rate={(ODBD−ODAD)/ODBD}×100%,
wherein ODBD is the optical density of a toner layer on developing roller before development and ODAD is optical density of a toner layer on developing roller after development.

3. The electrophotographic image forming device of claim 1, further comprising a collecting roller disposed farther downstream than the developing roller as viewed in a direction where the image holder is rotated,
wherein the bias applying unit applies to the collecting roller a collecting bias voltage that provides an electric field for transferring toner attached to the non-image portion on the image holder to the collecting roller.

4. The electrophotographic image forming device of claim 3, wherein a relationship among the electrical potentials of DC components of the developing bias voltage, the supply bias voltage, and the collecting bas voltage is given by:

|DCSB|>|DCDB|>|DCCB|

wherein DCSB is potential of direct current component of supply bias voltage, DCDB is potential of direct current component of developing bias voltage and DCCB is potential of direct current component of collecting bas voltage.

5. The electrophotographic image forming device of claim 4, wherein the magnetic roller is rotated so that a surface area of the magnetic roller adjacent to a surface area of the developing roller can move in a direction opposite to a direction in which the surface area of the developing roller moves.

6. The electrophotographic image forming device of claim 5, wherein a distance between the developing roller and the image holder is in the range of 150 to 400 μm.

7. The electrophotographic image forming device of claim 6, wherein a distance between the collecting roller and the image holder is no more than the distance between the developing roller and the image holder.

8. The electrophotographic image forming device of claim 6, wherein a distance between the developing roller and the magnetic roller is in the range of 0.2 to 1.0 mm.

9. An electrophotographic image forming device comprising:
an image holder on which an electrostatic latent image including an image portion and a non-image portion is formed;
a magnetic roller for forming by a magnetic force a magnetic brush comprising nonmagnetic toner and a magnetic carrier;
a developing roller and a collecting roller disposed upstream and downstream, respectively, as viewed in a direction of rotation of the image holder, between the image holder and the magnetic roller; and
a bias applying unit for applying to the magnetic roller a supply bias voltage effective in supplying toner to the developing roller and for applying to the developing roller a developing bias voltage effective in developing the toner into the electrostatic latent image, the developing bias voltage being a combination of a direct current (DC) and an alternating current (AC), and a collecting bias voltage effective in collecting toner attached to the non-image portion on the collecting roller,
wherein a difference between an electrical potential of the non-image portion and an electrical potential of a DC component of the developing bias voltage is less than or equal to a value at which a developing rate of the non-image portion is saturated, the developing rate being calculated using the following equation:
developing rate={(ODBD−ODAD)/ODBD}×100%,
wherein ODBD is the optical density of a toner layer on developing roller before development and ODAD is optical density of a toner layer on developing roller after development.

10. The electrophotographic image forming device of claim 9, wherein the magnetic roller rotates so that a surface area of the magnetic roller adjacent to surface areas a of the developing roller and the collecting roller can move in a direction opposite to a direction in which the surface areas of the developing roller and the collecting roller move.

11. A hybrid developing method, comprises:
supplying toner from a magnetic brush of a magnetic roller to a developing roller; and
applying a developing bias voltage to the developing roller to develop the toner into an electrostatic latent image on an image holder, wherein the developing bias voltage is set so that a difference between a potential of a direct current (DC) component of the developing bias voltage and an electrical potential of a non-image portion of the electrostatic latent image is no more than an electrical potential difference at which the developing rate of the non-image portion is saturated, and the set developing bias voltage reduces the adhesion of toner remaining on the developing roller after development to the developing roller.

12. The hybrid developing method of claim 11, wherein:
the magnetic roller is rotated so that a surface thereof can move in direction opposite to a direction in which a surface area of the developing roller moves; and
the magnetic brush of the magnetic roller contacts the developing roller to remove the toner remaining on the developing roller after development.

13. The hybrid developing method of claim 11, wherein the toner attached to the non-image portion on the developing roller is collected on a collecting roller disposed farther downstream than the developing roller as viewed in a rotating direction of the image holder by applying a collecting bias voltage to the collecting roller.

14. The hybrid developing method of claim 13, wherein:
the magnetic roller is rotated so that a surface thereof can move in direction opposite to a direction in which a surface areas of the developing roller and the collecting roller move; and
the magnetic brush of the magnetic roller contacts the developing roller and the collecting roller to remove the toner remaining on the developing roller after development and the toner detached from the non-image portion and collected on the collecting roller.
